(19) United States
(12) Patent Application Publication
(10) Pub. No.: US 2006/0149543 A1
(43) Pub. Date: Jul. 6, 2006

(54) Construction of an automaton compiling grapheme/phoneme transcription rules for a phoneticizer

(75) Inventor: Edmond Lassalle, Lannion (FR)

Correspondence Address: LOWE HAUPTMAN BERNER, LLP, 1700 DIAGONAL ROAD, SUITE 300, ALEXANDRIA, VA, 22314, US

(73) Assignee: FRANCE TELECOM, Paris (FR)

(21) Appl. No.: 11/295,689

(22) Filed: Dec. 7, 2005

(30) Foreign Application Priority Data
Dec. 8, 2004 (FR) 0413100
Dec. 8, 2004 (FR) 0413101

(51) Int. Cl. G10L 15/26

(52) U.S. Cl. 704/235

(57) ABSTRACT

A system checks the accuracy of a required graphic chain, e.g. usage errors. Modules constructs a phoneticizer by construction of an automaton compiling transcription rules and by determining probabilities of transitions between grapheme/phoneme correspondences. A dictionary of phonetic signatures is constructed by transcribing graphic chains from a graphic chains dictionary into phonetic signatures and linking the phonetic signatures to said graphic chains and determines probabilities of transcriptions of the graphic chains into the phonetic signatures. A transcription of the required graphic chain is determined into a request phonetic signature, and a probability of the preceding transcription is determined. In the phonetic signatures dictionary, phonetic signatures are looked up substantially identical to said required phonetic signature to derive therefrom attested graphic chains stored in the graphic chains dictionary.

### RELATED APPLICATIONS

The present application is based on, and claims priority to French Application Serial Number 0413100, filed Dec. 8, 2004, and French Application Serial No. 0413101, filed Dec. 8, 2004., the disclosure of which are hereby incorporated by reference herein in their entirety.

### BACKGROUND OF THE INVENTION

1. Field of the Invention

The present invention relates to the automatic processing of text by means of a system for checking for errors in a predetermined language. It relates more particularly to the construction by a computer of an automaton for compiling grapheme/phoneme transcription rules for automatic processing of grapheme/phoneme transcription in a predetermined language, to the construction by a computer of a phoneticizer to be integrated into a usage error checking system often included in a spellchecker, and to the operation of said checking system.

2. Description of the Prior Art

It is known in the art that the concatenative nature of grapheme/phoneme transcription uses a transcription system including a finite state automaton for effecting automatic processing of the transcription process.

The automaton of the transcription system has until now been constructed by the following steps. A first step defines a description language of the automaton. This is a formal framework describing transcription rules showing both the manner of coding each rule and the manner in which each rule is translated in the automaton. The description language is obtained by a sequential approach, for example, whereby the transcription procedure analyzes a graphic chain and applies the rules one after the other. Each interpretation gives rise to a local transformation of the analyzed graphic chain into a new chain, which is analyzed in turn in the next step of the transcription process. The sequential approach is executed by a progressive change from the graphic chain to a phonetic chain with mixed representations comprising graphemes and phonemes during intermediate steps of a phonological rule determination process. This progressive change is represented by a cascade of elementary automata each encompassing a packet of phonetic transcription rules reflecting an observed linguistic transcription phenomenon. The cascaded automata can be used as such in a cascaded analysis structure, as follows:

the grapheme is taken as input by the first automaton, which produces at its output a mixed representation comprising graphemes and phonemes in the same chain,

the representation produced in this way is taken as input by the second automaton, which in turn produces a new representation, and

that new representation becomes the input of the next automaton, and this procedure continues up to the last automaton, which outputs the final result.

Cascaded automata can be used on a computer for deterministic models which produce a single result at the output. For non-deterministic models, typically when there are several possible pronunciations of the same grapheme, cascaded analysis is generally not viable since each automaton output produces for the next automaton a plurality of inputs to be analyzed, which leads to an explosion of the results at the output, not to mention the difficulty of relative classification of the solutions at the output. In the case of non-deterministic models, one solution would be to combine the elementary automata into a single automaton having a very large number of states, which implies providing a very large memory space for the automaton.

A second automaton construction step involves a human expert, who must:

understand the description language of the rules previously defined,

know the nature of the transcription phenomena to be observed,

observe a transcription corpus, generalize the phenomena observed and translate them afterwards into transcription rules in the formal framework defined by the description language, and

thereafter revise or update the rules already described.

A third step of constructing the automaton of the transmission system implements a computer module for interpreting rules described by the human expert. An alternative to interpreting rules is to use a module for translating the rules into an executable program, or where applicable an interpretable program, in the form of an analysis table including a function for each transcription rule, for example. This second option, corresponding to compiling rules, proves difficult to implement because of the complex nature of the rule description language.

Generally, phonetic transcription rules are expressed naturally in the form of contextual rules. For example, in French, in the transcription of “an”, the corresponding phonetic form is “an” if “an” is followed by a consonant, for example as in the word “candidat”, and is retranscribed as “a˜” if “an” is followed by a vowel, for example as in “plane”. The difficulty of the transcription system stems both from the manner of automatically translating the transcription rules into an automaton without recourse to a human expert and the manner of describing said transcription rules. The identified defects of this type of transcription system are:

it is difficult to maintain rules that have been constructed by hand; the results frequently regress on adding a rule to extend the coverage of the processed phenomenon;

writing rules remains similar to programming and a person other than their author often has problems in evolving rules already written;

extending the predetermined language to regional characteristics necessitates virtually total rewriting of the rules;

coding the characters influences the writing of the rules: the transcription rules for the French language are different according to whether accented or non-accented characters are used.

At present a distinction is made between operational checking systems which check lexical or usage errors by processing the inaccurate writing of words and those that check syntax errors, relating to the articulation of phrases, or, more rarely, those that check the sense of phrases. The invention is aimed at the lexical errors that are encountered, which are traditionally of two types:

typographical errors linked to the use of a keyboard to enter text, such as wrong accents on certain graphical elements (characters); and

usage errors caused by a lack of knowledge of the exact orthography of graphic chains (words).

Usage error checking systems operate on the basis of a hypothesis as to the behavior of the user entering the text. If the user does not know the exact orthography, he tends to write the graphic chain as he would pronounce it. Checking therefore consists in determining a phonetic chain constituting a phonetic signature of the graphic chain to be checked and corrected, then extracting the corresponding signature from a dictionary of phonetic signatures, and finally determining the graphic chain or chains associated with the corresponding signature.

A checking system able to determine a more refined phonetic signature includes a phoneticizer for determining the transcription of a graphic chain into a phonetic chain constituting a phonetic signature. The phoneticizer is based on phonetic transcription rules each reflecting an observed linguistic phenomenon. The phonetic transcription rules are expressed naturally in the form of contextual rules depending on the immediate surroundings of the graphic chain.

The checking systems have the following defects:

it is difficult to maintain rules that have been constructed by hand; the results frequently regress on adding a rule to extend the coverage of the processed phenomenon;

writing rules remains similar to programming and a person other than their author often has problems in evolving rules already written;

the phoneticizer models, most of which are deterministic, cannot take account of variant pronunciations of the same graphic chain;

extending the predetermined language to regional characteristics necessitates virtually total rewriting of the rules; and

coding the graphical elements, for example the addition of accents or otherwise, for example, influences the writing of the transcription rules.

### OBJECTS OF THE INVENTION

The main object of the present invention is to circumvent the above drawbacks.

Another object of this invention is to automate the construction and compilation of phonological transcription rules. Accordingly, in a transcription process that is not to be supervised by a human expert, the rules must be produced by a simple analysis of an initial transcription corpus.

Yet another object of this invention is to automate the construction of an automaton for compiling the phonological transcription rules.

A further object of this invention is to automate the construction of a phoneticizer based on that automaton.

Another object of this invention is thereafter to integrate the phoneticizer into a usage error checking system.

### SUMMARY OF THE INVENTION

Accordingly, the invention consists in a method for construction by a computer of an automaton for compiling grapheme/phoneme transcription rules from an initial transcription corpus comprising pairs each made up of a graphic chain including graphic elements and a phonetic chain including phonetic elements. The automaton construction method is characterized in that it comprises the following steps, following registering grapheme/phoneme correspondences in a database by alignment of the graphic elements of the graphic chains with the phonetic elements of the phonetic chains associated with the graphic chains:

registering and storing transcription rules in the database on the basis of an analysis of left-hand and right-hand correspondences of each grapheme/phoneme correspondence in each pair of associated graphic and phonetic chains,

constructing said automaton including states and state transitions derived from the registered transcription rules, each state being a link between two consecutive grapheme/phoneme correspondences in a pair of graphic and phonetic chains and each transition chaining two states having a correspondence in common, and storing said automaton in the database in the form of a file.

The automaton of the invention is based on a parallel description language approach, differing from the sequential approach known in the art, in the use of states and transitions leading to a phonetic chain different from the graphic chain that is analyzed. The phonetic chain is constructed progressively and at the same time as the analysis of the graphic chain is progressing. All the transcription rules are recognized simultaneously as a set of constraints that must be satisfied in each grapheme to phoneme transcription step.

The automaton is constructed directly on the basis of the analysis of an initial transcription corpus, and evolution of the automaton consists simply in modifying the initial transcription corpus. The training methods used further enable the processing of all languages or language variants using an alphabet as a writing system. To obtain another automaton for processing another language, it suffices to obtain an initial grapheme/phoneme transcription corpus relating to the language to be processed.

According to a feature of the invention, the construction of the automaton includes creating and numbering states as a function of the registered transcription rules and chaining the states by transitions depending on correspondences common to the states.

According to another feature of the invention, constructing the automaton includes creating initial and final states respectively representative of start and end states of the automaton.

The invention also relates to a automaton construction computer system for implementing the automaton construction method of the invention, including a database in which is stored an initial transcription corpus comprising pairs each made up of a graphic chain including graphic elements and a phonetic chain including phonetic elements. The automaton construction computer system is characterized in that it includes:

a module for registering and storing transcription rules in the database on the basis of an analysis of left-hand and right-hand correspondences of each grapheme/phoneme correspondence in each pair of graphic and phonetic chains, all the correspondences being determined by an alignment module for aligning graphic elements of the graphic chains with phonetic elements of the phonetic chains in grapheme/phoneme correspondences stored in the database, and

a module for constructing said automaton and storing it in the form of a file in the database, the automaton including states and state transitions derived from the registered transcription rules, each state being a link between two consecutive grapheme/phoneme correspondences in a pair of graphic and phonetic chains, and each transition chaining two states having a correspondence in common.

The invention relates to a first computer program adapted to be executed on the automaton construction computer system of the invention. The program includes program instructions which execute the steps of the automaton construction method of the invention when the program is loaded into and executed in the automaton construction computer system.

The invention also relates to a phoneticizer construction method for the construction by a computer of a phoneticizer from a corpus stored in a database and comprising pairs each made up of a graphic chain including graphic elements and a phonetic chain including phonetic elements. The phoneticizer construction method is characterized in that it includes the following steps:

constructing by computer and storing in the database an automaton for compiling transcription rules resulting from an analysis of grapheme/phoneme correspondences in pairs of chains read in the corpus, said automaton including states and state transitions derived from transcription rules, each state being a link between two consecutive grapheme/phoneme correspondences in a pair of graphic and phonetic chains, and each transition chaining two states having a grapheme/phoneme correspondence in common, the transitions relating to the transcription of a graphic chain into a phonetic chain forming a path of transitions in the automaton, and

determining and storing in the database probabilities of the transitions at the output of nodes of the automaton situating the grapheme/phoneme correspondences common to the transitions, in order to construct the phoneticizer by combining the automaton and the determined transition probabilities.

The phoneticizer of the invention is stochastic and therefore non-deterministic since it transcribes a graphic chain into one or more phonetic chains, known as phonetic signatures, depending on multiple pronunciations. The phoneticizer is constructed automatically on the basis of an analysis of the corpus and can be enhanced by enriching the corpus, in particular as the language of the corpus evolves.

Since the phoneticizer is based on a corpus, the invention is capable of constructing a plurality of phoneticizers using a corpus compatible respectively with different languages.

The transition probability determining step may include the following sub-steps:

weighting each transition of the automaton by an arbitrarily selected transition probability,

determining a probability of at least one path of transitions representative of the transcription of each graphic chain into at least one associated phonetic chain as a function of the probabilities of the transitions of the path,

selecting for each graphic chain of the path transitions having the highest probability,

incrementing variables respectively associated with the transitions and representative of numbers of crossings of the transitions by the selected transition paths, and

estimating new transition probabilities as a function of the transition variables previously determined.

The transition probability determining step may further include reiterating the steps of path probability determining, selecting, incrementing and estimating as a function of new transition probabilities until significant convergence of said transition probabilities is obtained, in order to combine the automaton and the transition probabilities in the phoneticizer.

The invention also relates to a computer system for constructing a phoneticizer. The system is characterized in that it includes:

a module for constructing by computer and storing in the database an automaton for compiling transcription rules resulting from an analysis of grapheme/phoneme correspondences in the pairs of chains read in the corpus, said automaton including states and state transitions derived from transcription rules, each state being a link between two consecutive grapheme/phoneme correspondences in a pair of graphic and phonetic chains, and each transition chaining two states having a grapheme/phoneme correspondence in common, the transitions relating to the transcription of a graphic chain into a phonetic chain forming a path of transitions in the automaton, and

a module for determining and storing in the database probabilities of the transitions at the output of nodes of the automaton situating the grapheme/phoneme correspondences common to the transitions, in order to construct the phoneticizer by combining the automaton and the determined transition probabilities.

The invention further relates to a second computer program adapted to be executed on the phoneticizer construction computer system of the invention. The second program includes program instructions which execute the steps of the phoneticizer construction method of the invention when the program is loaded into and executed in the phoneticizer construction computer system.

The invention also relates to a use of a phoneticizer constructed in accordance with the invention. To this end, a computer method of checking the accuracy of a required graphic chain by means of a phoneticizer and a computer dictionary of graphic chains is characterized in that it includes the following steps:

constructing the phoneticizer by computer construction of an automaton for compiling transcription rules resulting from an analysis of grapheme/phoneme correspondences in pairs of graphic and phonetic chains read in a corpus and determining probabilities of transitions between grapheme/phoneme correspondences,

using the phoneticizer to construct a computer dictionary of phonetic signatures by transcribing each of the graphic chains from the graphic chains dictionary into at least one phonetic signature, linking the phonetic signatures by computer means to the graphic chains, and determining probabilities of transcription of the graphic chains into the phonetic signatures,

using the phoneticizer to determine a transcription from the required graphic chain into at least one request phonetic signature and determining a probability of the preceding transcription, and

looking up phonetic signatures in the phonetic signatures dictionary substantially identical to said at least one request phonetic signature to derive therefrom attested graphic chains stored in the graphic chains dictionary and linked to said at least one phonetic signature.

The invention further relates to a computer system for checking the accuracy of a required graphic chain. That system includes a phoneticizer and a computer dictionary of graphic chains and is characterized in that it includes:

means for constructing the phoneticizer by computer construction of an automaton for compiling transcription rules resulting from an analysis of grapheme/phoneme correspondences in pairs of graphic and phonetic chains read in a corpus and by determining probabilities of transitions between grapheme/phoneme correspondences,

means aided by the phoneticizer for constructing a computer dictionary of phonetic signatures by transcribing each of the graphic chains from the graphic chains dictionary into at least one phonetic signature and linking the phonetic signatures by computer means to the graphic chains,

means aided by the phoneticizer for determining probabilities of transcriptions of the graphic chains into the phonetic signatures,

means aided by the phoneticizer for determining a transcription of the required graphic chain into at least one request phonetic signature,

means for determining a probability of the preceding transcription, and

means for looking up in the phonetic signatures dictionary phonetic signatures substantially identical to said at least one required phonetic signature to derive therefrom attested graphic chains stored in the graphic chains dictionary and linked to said at least one phonetic signature.

The invention further relates to a third computer program adapted to be executed on the graphic chain accuracy checking computer system of the invention. The third program includes program instructions which execute the steps of the graphic chain accuracy checking method of the invention when the third program is loaded into and executed in the computer system.

In this context, the invention also provides a phoneticizer for transcribing a required graphic chain into a phonetic signature using a computer dictionary of graphic chains. The phoneticizer includes means for constructing a computer dictionary of phonetic signatures, means for determining graphic chain transcription probabilities, means for determining a transcription of the required graphic chain and means for determining a probability of the preceding transcription.

### BRIEF DESCRIPTION OF THE DRAWINGS

Other features and advantages of the present invention will be apparent more clearly from the reading of the following description of several preferred embodiments of the invention, given by way of nonlimiting examples and with reference to the corresponding accompanying drawings, in which:

FIG. 1 is a block diagram of a computer system of the invention;

FIG. 2 is an algorithm of the construction by a computer of the phoneticizer of the invention;

FIG. 3 is an algorithm of the construction of an automaton for compiling transcription rules;

FIG. 4 is a diagram of a chain of states of the automaton;

FIG. 5 is an algorithm of an alignment sub-method of the automaton construction method of the invention;

FIG. 6 is an algorithm of a transcription rules registering sub-method of the automaton construction method of the invention;

FIGS. 7 and 8 represent an algorithm of a chaining sub-method of the automaton construction method of the invention;

FIG. 9 is a construction algorithm of a stochastic phoneticizer of the invention; and

FIG. 10 is a usage error checking method algorithm used in a usage error checking system including the phoneticizer of the invention.

### DESCRIPTION OF THE PREFERRED EMBODIMENTS

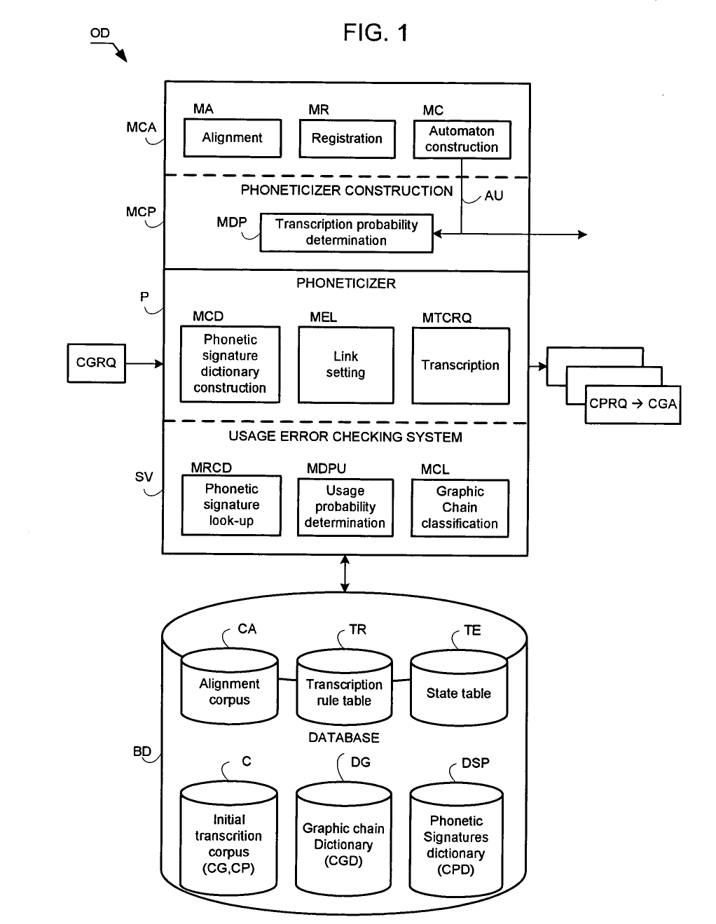

Referring to FIG. 1, a computer system of the invention, consisting of a computer OD or a server, constructs an automaton AU of the invention and a stochastic phoneticizer P of the invention. The computer system of the invention also provides the functions of a usage error checking system SV including said phoneticizer. The checking system SV determines one or more graphic chains that constitute attested solutions to an erroneous, or even unknown, required graphic chain included in a request.

After constructing the automaton AU, the computer sends instructions and data representing functions of the automaton AU, for example in the form of a file, to an analyzer installed in a server, for example. The analyzer transcribes graphic chains applied to the input of the analyzer into resulting phonetic chains at the output of the analyzer, for example in the context of spellchecking during looking up a patronymic in a directory.

In a similar manner, after constructing the phoneticizer, the computer OD may compile instructions and data representing the phoneticizer in a file and transmit the file to another computer system.

The computer OD incorporates a database BD of the type used in artificial intelligence or accesses a server managing the database locally or through a telecommunication network. The database initially stores an initial transcription computer corpus C and a graphic chains computer dictionary DG in the form of files.

The corpus C includes pairs made up of graphic chains CG and phonetic chains CP, each graphic chain CG including graphic elements gₘ and each phonetic chain CP including phonetic elements pₙ. The graphic chains dictionary DG includes graphic chains CGD, for example patronymics or words from a directory in a predetermined language. An alignment corpus CA, a transcription rules table TR and a states table TE are created and stored in database BD during execution of the method of constructing the automaton and compiling the transcription rules. During functioning of the usage error checking system, the database stores a phonetic signatures dictionary DSP including phonetic chains CPD known as phonetic signatures and produced from the transcribed graphic chains CGD taken from the graphic chains dictionary DG.

The computer OD includes a module MCA for constructing the automaton AU of the invention. Module MCA includes an alignment module MA for aligning graphic chain graphemes and phonetic chain phonemes in corresponding relationship belonging to an initial transcription corpus C, a registration module MR for registering transcription rules, and a construction module MC for constructing a finite state automaton AU compiling the transcription rules R. The computer OD also includes a module MCP for constructing the stochastic phoneticizer P of the invention. Module MCP cooperates with module MCA and includes a transcription probability determination module MDP using the automaton AU to determine the probabilities of transcription of a graphic chain into one or more phonetic chains.

The computer OD also includes modules of the phoneticizer P, after the construction thereof, and function modules of the usage error checking system SV.

The phoneticizer P includes:

a construction module MCD for constructing the phonetic signatures dictionary DSP from the transcription of the graphic chains CGD from the graphic chains dictionary DG by the stochastic phoneticizer P;

a link set-up module MEL for setting up links between the phonetic signatures CPD from the phonetic signatures dictionary DSP and the corresponding graphic chains CGD from the graphic chains dictionary DG, a phonetic signature being linkable to one or more graphic chains and vice versa; and

a stochastic transcription module MTCRQ for transcribing a required graphic chain CGRQ of a request to one or more request phonetic signatures CPRQ.

The checking system SV includes:

a look-up module MRCD for looking up phonetic signatures CPD in the phonetic signatures dictionary DSP as a function of phonetic chains CPRQ resulting from the transcription of the required graphic chain CGRQ;

a usage probability determination module MDPU for determining probabilities of use of attested graphic chains CGA associated with the phonetic signatures CPRQ; and

a classification module MCL for classifying the attested graphic chains CGA according to their usage probabilities.

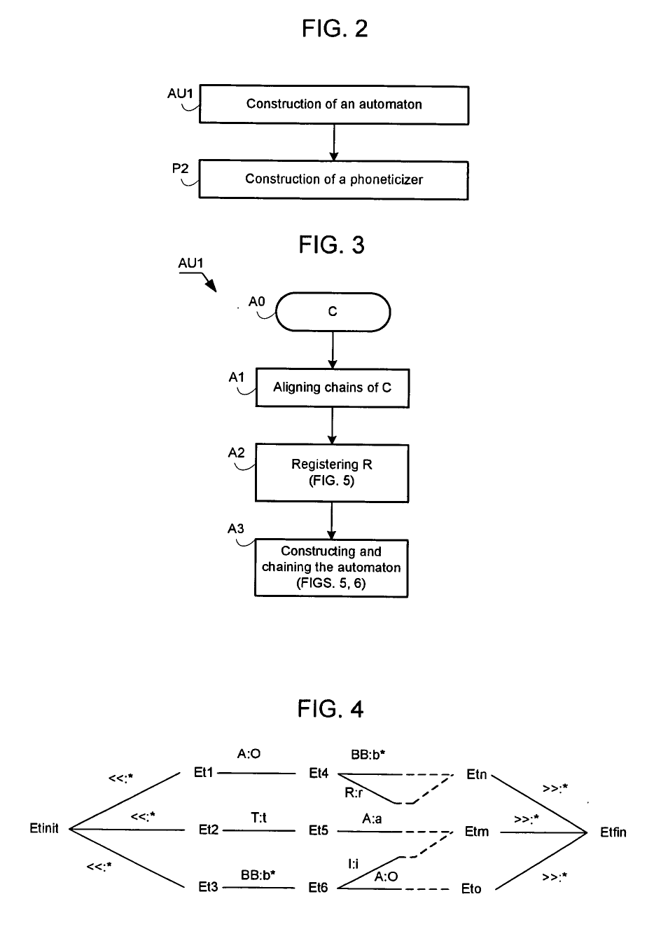

As shown in FIG. 2, the method of the invention of constructing the phoneticizer includes main steps AU1 and P2. These steps are executed in the form of a program implemented in the computer OD.

For the purposes of describing the phonetization phenomenon to be taken into account, the computer OD initially has access to the grapheme/phoneme corpus C in the database BD. The module MCA of the computer OD analyzes the corpus C and extracts from it pairs of graphic and phonetic chains to derive therefrom transcription rules compiled in a transcription automaton AU in the step AU1. Automaton AU for compiling transcription rules in accordance with the invention and constructed by computer means has the function of recognizing the validity of a graphic chain CG to achieve effective transcription into a phonetic chain CP. The automaton constructed in this way is non-deterministic since a given graphic chain corresponds to one or more possible phonetic chains, known as phonetic signatures. The step AU1 is described in detail in the description of FIGS. 3 to 8.

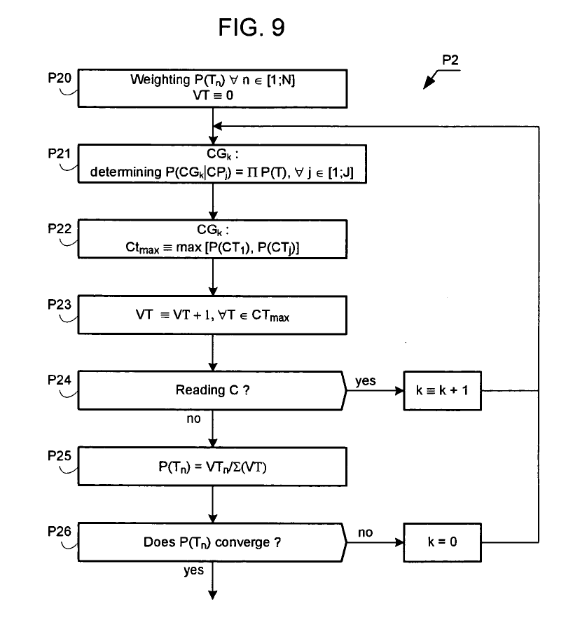

The module MDP of the computer OD then constructs the phoneticizer in the step P2 by determining probabilities of transitions at nodes of the automaton. The step P2 is described in detail in the description of FIG. 9.

FIG. 3 illustrates the above automaton construction step AU1 including sub-steps A0 to A3. For the most part these steps are executed in the form of a program implemented in the computer OD and able to be linked to a lexical error correction system that may be integrated into a word processing system or a language practice system, for example. The initial transcription corpus C in the database BD includes transcriptions that establish correspondences between graphic chains CG such as words or patronymics, each made up of one or more typographical elements (characters), hereinafter referred to as graphic elements gₘ, gₐ, of an alphabet G={g₁, . . . , g_{A}} with A elements of the predetermined language, with respective phonetic chains CP, each made up of one or more phonetic elements pₙ, p_{b} of an alphabet P={P₁, . . . , p_{B}} with B phonetic elements, where A≠B a priori. The following is an example of an extract from a corpus C when the predetermined language is English:

ABBREVIATE obriviat

ABBREVIATED obriviatod

ABBREVIATES obriviats

ABBREVIATING obriviatiG

ABBREVIATION obriviaSon

ABBREVIATIONS obriviaSonz

ABBRUZZESE obrutsazi.

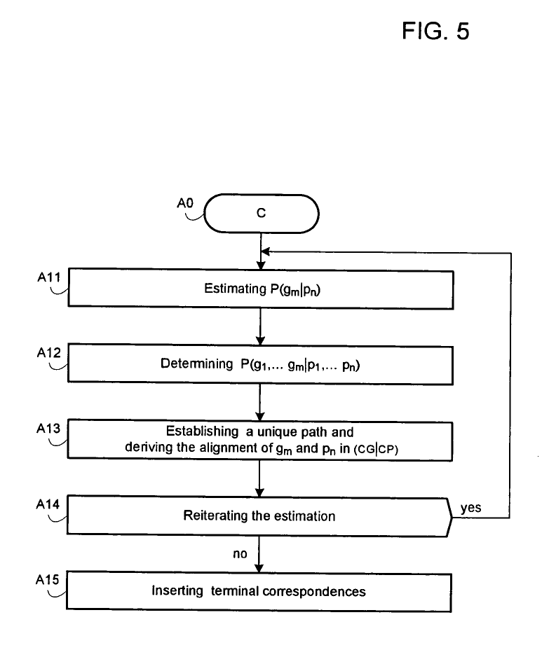

After reading the initial transcription corpus C in the step A0, the aligning module MA uses a syllabification process in the step A1 to align graphemes and phonemes of type gᵢ:pᵢ of the elementary transcriptions. The elementary transcription gᵢ:pᵢ is a correspondence or transduction between one or more graphic elements gₘ of a graphic chain CG constituting a grapheme gᵢ and one or more phonetic elements pₙ of the associated phonetic chain CP constituting a phoneme pᵢ. The alignment step A1 is described in detail during the description of FIG. 5.

With reference to the extract from the corpus C cited above, the module MA supplies the following correspondences in the step A1:
<<A BB R E V I A TE>>
* o b* r i v i a t* *
<<A BB R E V I A T E D>>
* o b* r i v i a t o d *
<<A BB R E V I A TE S>>
* o b* r i v i a t* s *
<<A BB R E V I A T IN G>>
* o b* r i v i a t i* G *
<<A BB R E V I A TI O N>>
* o b* r i v i a s* o n *
<<A BB R E V I A TI O N S>>
* o b* r i v I a s* o n z *
<<A BB R U Z Z E S E>>
* o b* r u t s a z i *

In each of the line pairs above representing transcriptions of chains, the upper line represents the graphic chain CG divided into M graphic elements gₘ and the lower line represents the associated phonetic chain CP divided into N phonetic elements pₙ. The symbol * designates a mute phonetic element with no meaning. These grapheme/phoneme correspondences, or translations, are stored in the database BD to constitute the alignment corpus CA progressively. The graphic symbols <<and>>associated with the phonetic symbol * indicate terminal correspondences marking the beginning and the end, respectively, of each pair of graphic and phonetic chains.

On the basis of this grapheme/phoneme alignment, the registration module MR of the computer OD registers transcription rules R in the step A2. A transcription rule Rᵢ is represented in the following manner:
gᵢ:pᵢ [symbol] gᵢ₋₁:pᵢ₋₁_{_{—}}gᵢ₊₁:p_{i+1,}
in which gᵢ₋₁:pᵢ₋₁ is the left-hand correspondence and gᵢ₊₁:pᵢ₊₁ is the right-hand correspondence of the correspondence gᵢ:pᵢ in the graphic chain CG=( . . . , gᵢ₋₁,gᵢ, gᵢ₊₁, . . . ) and the associated phonetic chain CP=( . . . , pᵢ₋₁, pᵢ, pᵢ₊₁, . . . ). The rule transcribes a correspondence of a grapheme gᵢ into a phoneme pᵢ as a function of the contexts bracketing the correspondence. The left-hand, respectively right-hand, context of the correspondence consists of one or more correspondences situated to the left, respectively to the right, of said correspondence. In one variant of the invention, a single correspondence on the left, respectively on the right, suffices.

For example, given the following alignment:
A BB R E V I A TE
o b* r i v i a t*
   the module MR derives for the correspondence BB:b the following rule:
   BB:b* [symbol] A:o_R:r

This rule means that it is necessary and sufficient for the correspondence situated to the left of a given correspondence to be A:o and the correspondence situated to the right of the given correspondence to be R:r for the given correspondence to be BB:b*.

For correspondences at the start and the end of each pair of chains, the alignment module MA inserts in the step A1 terminal correspondences <<:* and>>:* designating the left-hand and right-hand end contexts of the chains. For the above example, the module MA establishes the following terminal rules:
A:o [symbol] <<:*_BB:b* and
E:i [symbol] S:z_>>:*

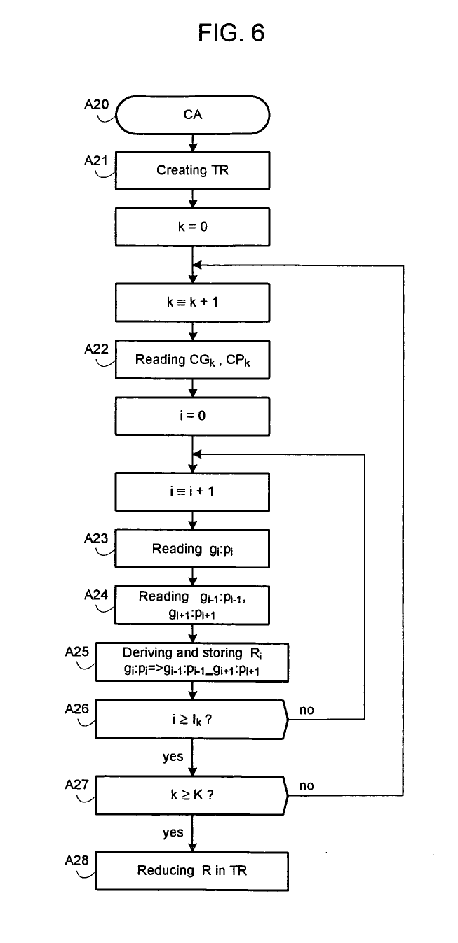

The step A2 of registering transcription rules is described in detail in the description of FIG. 6.

In the step A3, the automaton construction module MC constructs the automaton compiling the registered transcription rules R. The automaton includes states Et and transitions T derived from the analysis of each transcription rule R. A state defines a link between two consecutive correspondences in associated graphic and phonetic chains. A transcription rule has two states of the automaton. For example, for a rule Rᵢ such that:
gᵢ:pᵢ [symbol] gᵢ₋₁:pᵢ₋₁_{_{—}}gᵢ₊₁:pᵢ₊₁,
a first state defines the link between the correspondence gᵢ₋₁:pᵢ₋₁ and the correspondence gᵢ:pᵢ and a second state defines the link between the correspondence gᵢ:pᵢ and the correspondence gᵢ₊₁:pᵢ₊₁. Each state Et_{q}=g1_{q}:p1_{q}_{_{—}}g2_{q}:p2_{q} therefore represents a link between a first correspondence g1_{q}:p1_{q} and a second correspondence g2_{q}:p2_{q}. An initial state Etinit and a final state Etfin that do not depend on transcription rules are created during the execution of the method.

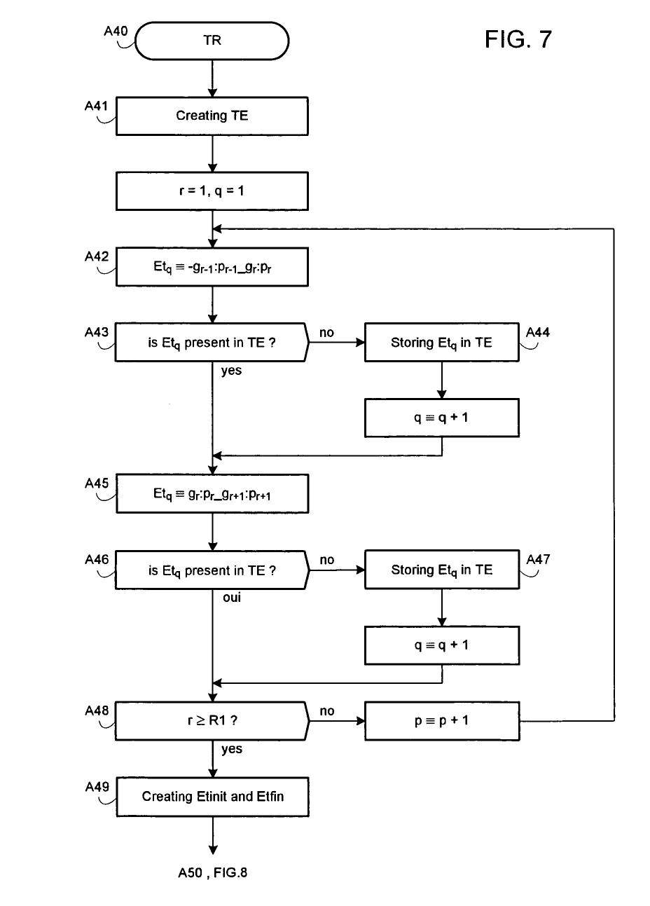

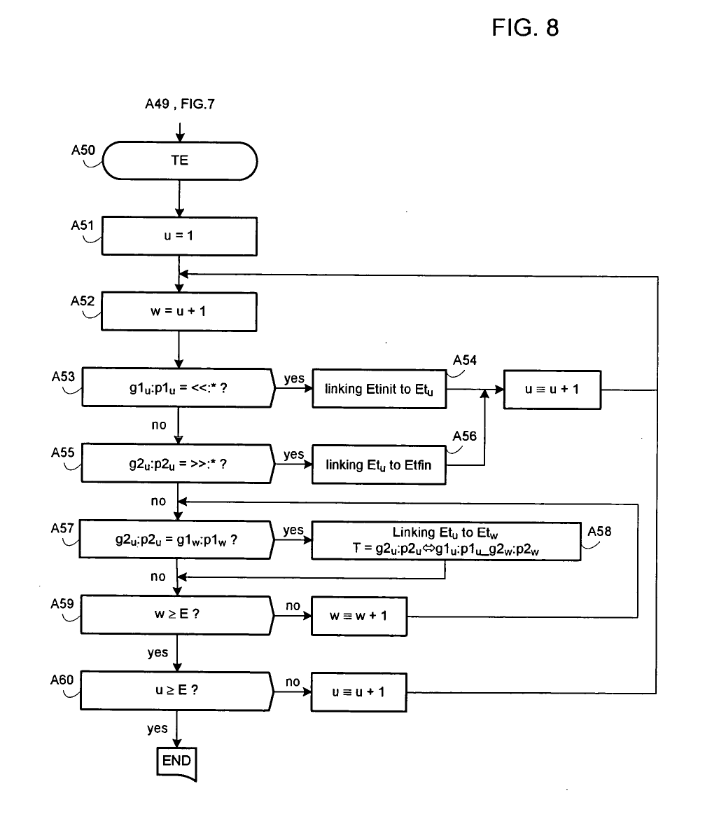

The construction module MC also effects the chaining for linking the states Et to each other by transitions T as a function of the analysis of each registered transcription rule R. The step A3 for constructing a finite state automaton compiling all the transcription rules is described in detail in the description of FIGS. 7 and 8.

Each transition T of the automaton chains two states having the same correspondence in common. All the transitions T relating to the transcription of a graphic chain into a phonetic chain belong to the same transitions path CT in the automaton.

At the end of execution of the automaton construction step AU1 (A0-A3), the automaton compiling all the registered transcription rules R from the corpus C is constructed as shown in FIG. 4 and stored in the database BD in the form of a file. In FIG. 4 the automaton is diagrammed as a mesh whose nodes situate the states. Transition paths CT in the mesh begin at the initial state Etinit, cross the nodes and terminate at the final state Etfin. FIG. 4 diagrams the automaton beginning with the initial state that is chained to states Et1, Et2 and Et3 including a start terminal correspondence <<:*. For example the state Et1=<<:* _A:o is linked to the initial state. Each state is chained at least to one other state in accordance with a transition equivalent to the transcription rule associating the two states of the transition. For example the state Et1 is chained to the state Et4 according to the transcription rule T=A:o [symbol] <<:*_BB:b*, also called a transition. Any state including an end terminal correspondence >>:* is chained to the final state Etfin.

FIG. 5 shows sub-steps A11 to A15 of the step A1 executed by the alignment module MA in relation to the correspondence of each graphic element gₘ of a graphic chain CG to each phonetic element pₙ of the associated phonetic chain CP. The alignments executed in the step A1 result from an analysis of all the pairs of chains (CG, CP) in the corpus C.

The alignment step is based on reading in the step A0 the initial transcription corpus C including the graphic chains CG made up of M graphic elements gₘ and the phonetic chains CP associated with the graphic chains CG and made up of N phonetic elements pₙ.

In the sub-step A11, first correspondence probabilities P(gₘ|pₙ) that a graphic element gₘ will correspond to the phonetic element pₙ are estimated as a matter of priority from the graphic chains CG and the phonetic chains CP of the initial transcription corpus C, and are stored in the database BD with the transcription corpus C. The first probability for the correspondence gₘ:pₙ is stated as a function in particular of the number of times that the graphic element gₘ is retranscribed in the phonetic element pₙ in the diverse transcriptions of the graphic and phonetic chains CG, CP included in the corpus C and as a function of the rank of the phonetic element pₙ in the phonetic chain CP derived from the rank of the graphic element gₘ in the graphic chain CG.

In the sub-step A12, the second probabilities P(g₁, . . . gₘ|p₁ . . . pₙ) are determined for each graphic chain CG and each phonetic chain CP of the transcription corpus C. The graphic chain C comprises M consecutive graphic elements g₁ to g_{M} and the phonetic chain CP corresponding to the chain CG comprises N consecutive phonetic elements p₁ to p_{N} with the integer N either different from or where applicable equal to the integer M. The probability P(CG|CP) is determined by dynamic programming using the following iteration formula for any pair m,n such that 1≦n≦N and 1≦m≦M:
P(g₁g₂ . . . gₘ|p₁p₂ . . . pₙ)=P(gₘ|pₙ)max [P(g₁g₂ . . . gₘ₋₁|p₁p₂ . . . pₙ),
P(q₁g₂ . . . gₘ|p₁p₂ . . . pₙ₋₁), P(g₁g₂ . . . gₘ₋₁|p₁p₂ . . . pₙ₋₁)]
where P(gₘ|pₙ) is the first elementary transcription probability estimated in the preceding sub-state A11 that a graphic element gₘ will correspond to the phonetic element pₙ and where P(g₁g₂ . . . gₘ₋₁|p₁p₂ . . . pₙ), P(g₁g₂ . . . gₘ|p₁p₂ . . . pₙ₋₁) and P(g₁g₂ . . . gₘ₋₁|p₁p₂ . . . pₙ₋₁) are three second probabilities determined during the preceding iterations. On each iteration, the alignment module MA constructs and stores progressively a matrix of second probabilities P(g₁, . . . gₘ|p₁, . . . pₙ) with M columns for successive concatenations of the M graphic elements and with N rows for successive concatenations of the N phonetic elements, operating row by row, starting with the probability P(g₁|p₁) and ending with the probability P(g₁, . . . g_{M}|p₁, . . . p_{N}).

In the sub-step A13, each iteration relative to the (m.n)^{th} transcription [(g₁, . . . gₘ)|(p₁, . . . pₙ)] establishes a link between the pair (gₘ, pₙ) and the pair with the highest probability of the three second probabilities determined beforehand from the three pairs ((gₘ₋₁, pₙ), (gₘ, pₙ₋₁) and (gₘ₋₁, pₙ₋₁). Accordingly a link is stored in the module MA on each determination of the probability P(g₁, . . . gₘ)|(p₁, . . . pₙ). The links trace a unique path that is stored progressively in the module MA and links the first pair (g₁, p₁) to the last pair (g_{M}, p_{N}) in the matrix with M columns and N rows. The topology of the single path in the M.N matrix segments the graphic chains CG into graphemes and the phonetic chains CP into phonemes and aligns the graphic elements gₘ and the phonetic elements pₙ in one-to-one correspondence.

Where applicable, thanks to the high processing capacity of the computer OD, other iterative loops of sub-steps A11 to A13 may be executed in the sub-step A14 until the alignment step A1 converges, i.e. until the path that has been established remains constant from one loop to the next.

At the end of the step A1, in the sub-step A15, for each pair of segmented graphic and phonetic chains, there are inserted a terminal grapheme/phoneme correspondence placed at the start <<:* of the pair of graphic and phonetic chains and an end terminal grapheme/phoneme correspondence >>:* placed at the end of the pair of graphic and phonetic chains. The results of the alignment are then stored in the alignment corpus CA of aligned graphic chains and phonetic chains in the database BD.

Referring to FIG. 6, in the step A2 including the sub-steps A20 to A28, the registration module MR registers the transcription rules R from correspondences supplied by the alignment corpus CA in the database BD.

Following reading of the alignment corpus CA in the sub-step A20, the registration module MR creates the table TR of transcription rules in the database BD in the sub-step A21. Remember that a rule depends on the left-hand and right-hand correspondences of a grapheme/phoneme correspondence gᵢ:pᵢ.

The registration module MR registers the rules by iteration on pointers in the corpus CA relating to the index k of the pairs of chains CGₖ, CPₖ and the index i of the correspondences gᵢ:pᵢ in the corpus CA, with 1≦I≦Iₖ and 1≦k<K, so as to read a pair comprising a graphic chain CGₖ and a phonetic chain CPₖ in the sub-step A22 and a correspondence gᵢ:pᵢ of that pair of chains in the sub-step A23. The registration module MR reads the left-hand correspondence gᵢ₋₁:pᵢ₋₁ and the right-hand correspondence gᵢ₊₁:pᵢ₊₁ in the sub-step A24 of the correspondence gᵢ:pᵢ. The module MR then derives therefrom the associated transcription rule Rᵢ:
gᵢ:pᵢ [symbol] gᵢ₋₁:pᵢ₋₁_{_{—}}gᵢ₊₁:pᵢ₊₁

and stores it in the table TR of transcription rules in the sub-step A25. As long as all the correspondences of the graphic chains CGⱼ and the phonetic chains CPₖ, including a number of correspondences Iₖ, are not read in the sub-step A26, the module MR places the pointer i on the next correspondence gᵢ₊₁:pᵢ₊₁ after the sub-step A26. Then, as long as all the graphic chains and the phonetic chains of the alignment corpus CA including K pairs of chains are not read, the module MR places the pointer k on the pair of graphic chains CGₖ₊₁ and phonetic chains CPₖ₊₁ after the sub-step A27.

When all the transcription rules R have been registered and stored in the table TR, the registration module eliminates all the redundant rules in the table TR in the sub-step A28.

Referring now to FIGS. 7 and 8, the construction module MC executes sub-steps A40 to A60 of the finite state automaton construction step A3. This automaton construction includes a first phase A40-A49 for creating and numbering states Et of the automaton and a second phase A50-A60 for chaining states Et together in accordance with the transcription rules R stored in the rules table TR.

At the start of the first phase, in the sub-step A40, the construction module MC progressively reads the R1 transcription rules included in the table TR. In the sub-step A41, the construction module MC creates the automaton states table TE in the database BD.

On each reading of a transcription rule Rᵣ designated by a pointer r in the rules table TR, a first stage is defined in the sub-step A42, corresponding to the link between the correspondence gᵣ:pᵣ expressed by the rule Rᵣ and its left-hand correspondence gᵣ₋₁:pᵣ₋₁. The state is represented in the following manner: Et_{q}=gᵣ₋₁:pᵣ₋₁ gᵣ:pᵣ. In the sub-step A43, the construction module MC checks that the state Et_{q} is present in the states table TE. If the state Et_{q} is new, in the sub-step A44, the module MC stores and numbers the state Et_{q} by means of the subscript q in the states table TE and increments the subscript q.

Then, in the sub-step A45, and still in accordance with the transcription rule Rᵣ, there is defined a second state corresponding to the link between the correspondence gᵣ:pᵣ expressed by the rule Rᵣ and its right-hand correspondence gᵣ₊₁:pᵣ₊₁. The state is represented in the following manner: Et_{q}=gᵣ:pᵣ gᵣ₊₁:pᵣ₊₁. In the sub-steps A46 and A47, as in the sub-steps A43 and A44, the construction module MC checks the presence of the states Et_{q} in the states table TE, and if the state Et_{q} is new, the module stores and numbers the state Et_{q} by means of the subscript q in the states table TE and increments the subscript q. Otherwise, if the rules have not yet all been pointed to in the sub-step A48, the module MC proceeds to determine states relative to other rules.

As soon as all the states relating to the transcription rules have been created, in the sub-step A49, the construction module MC creates an initial state Etinit and a final state Etfin independent of the transcription rules R.

Referring to FIG. 8, at the start of the second phase, in the sub-step A50, the construction module MC progressively reads the states table TE in order to chain the states by means of links. To construct each link between two states, the construction module MC increments two pointers u and w in the table TE in order to compare the state designated by the first pointer u to the state designated by the second pointer w. As explained above, a state Et=g1ᵤ:p1ᵤ_{_{—}}g2ᵤ:p2ᵤ links a first correspondence g1ᵤ:p1ᵤ to a second correspondence g²ᵤ:p²ᵤ. In the sub-step A51, the first pointer u designates a state Etᵤ in the states table TE and in the sub-step A52 the second pointer w designates the next state Etᵤ=Etᵤ₊₁ in the table TE.

Starting from the state Etᵤ designated by the first pointer u, in the sub-step A53, the construction module MC compares the first correspondence g1ᵤ:p1ᵤ of that state with the chain start terminal correspondence <<:*. If g1ᵤ:p1ᵤ corresponds to <<:*, in the sub-step A54, the construction module MC links the initial state Etinit to the state Etᵤ and the two pointers are then incremented. If g1ᵤ:p1ᵤ does not correspond to <<:*, in the sub-step A55, the construction module MC compares the second correspondence g2ᵤ:p2ᵤ of the state Etᵤ to the chain end terminal correspondence >>:*. If g2ᵤ:p2ᵤ corresponds to >>:*, in the sub-step A56, the construction module links the final state Etfin to the state Etᵤ and the two pointers are incremented.

If g1ᵤ:p1ᵤ does not correspond to <<:* and g2ᵤ:p2ᵤ does not correspond to >>:*, the module MC executes several iterations of the sub-steps A57 to A60. On each iteration, in the sub-step A57, the module MC compares the second correspondence g2ᵤ:p2ᵤ of the state Etᵤ to the first correspondence g1_{w}:p1_{w} of the state Etᵤ designated by the second pointer w. If g2ᵤ:p2ᵤ is identical to g1_{w}:p1_{w}, in the sub-step A58, the construction module links the state Etᵤ to the state Et_{w} by a transition T that is equivalent to a transcription rule R and which chains the two states Etᵤ and Et_{w} as follows: T=g2ᵤ:p2ᵤ [symbol] g1ᵤ:p1ᵤ_{_{—}}g2_{w}:p2_{w}, where g1ᵤ:p1ᵤ is the left-hand correspondence of the correspondence g2ᵤ:p2ᵤ (=g1_{w}:p1_{w}) and g2_{w}:p2_{w} is the right-hand correspondence of the correspondence g2ᵤ:p2ᵤ common to the states Etᵤ and Et_{w}. If the second pointer w has not reached the number E of states in the state table TE, in the sub-step A59, the pointer w is incremented and the comparison of the sub-step A57 is repeated. Likewise, if the first pointer u has not reached the number of states E, in the sub-step A60, the pointer u is incremented.

Each transition representing a link of the chain between two states determined by the construction module MC is stored in the states table TE.

At the end of the chaining, the module MC compiles all the transcription rules R that have been determined on the basis of the alignment corpus CA in order to construct the automaton AU made up of a mesh of transductors corresponding to the respective states Et and linked by transitions T in accordance with the deontogical rules R. The automaton is stored in the database BD and subsequently read by the computer OD to transmit it to the phoneticizer constructing module MCP and/or an analyzer server. For example, the analyzer server looks up a word or a name in a directory from a request transmitted from a user terminal and including a misspelt word or name that is applied to the automaton, the predetermined language of the automaton being that of the directory.

As shown in FIG. 9, the step P2 of constructing a phoneticizer on the basis of the automaton previously constructed includes sub-steps P20 to P26 executed by the module MDP of the computer OD for estimating automaton transition probabilities P(T).

Assuming that the automaton includes N transitions T₁ to T_{N}, the first sub-step P20 weights each transition Tₙ of the automaton by a transition probability P(Tₙ), with 1≦n≦N. The transition probabilities are initially selected arbitrarily with values that respect the following condition: at each node formed by the intersection of transitions and corresponding to states, the sum of the transition probabilities outgoing from the node in the direction from the start terminal correspondence to the end terminal correspondence is equal to 1. For each transition Tₙ, a variable VT associated with the transition and representative of the number of crossings of the transition Tₙ by paths traveled during chain transcriptions is defined and set to zero.

In the sub-step P21, for a given graphic chain CGₖ designated by a pointer k in the corpus C, the module MDP reads the graphic chain CGₖ and determines, in the automaton, probabilities P(CGₖ|CP₁)=P(CT₁) to P(CGₖ|CP_{J})=P(CT_{J}) for the transcription of the graphic chain CGₖ into J associated phonetic chains CP₁ to CP_{J} in the corpus C. For each associated phonetic chain CPⱼ, where 1≦j≦J and the integer J≧1, there is traveled in the automaton a transitions path CTⱼ reflecting the succession of transitions T describing the transcription (CGₖ|CPⱼ) between the graphic chain CGₖ and the associated phonetic chain CPⱼ. The transcription probability P(CGₖ|CPⱼ)=P(CTⱼ) is the product of the probabilities P(T) of the transitions T along the transitions path CTⱼ.

Then, in the sub-step P22, the module MDP selects from the transitions paths CT₁ to CT_{J} relating to the graphic chain CGₖ the transitions path CTₘₐₓ with the highest transcription probability P(CGₖ|CP).

In the sub-step P23, the module MDP increments by one unit the variables VT for which the transitions T form the transitions path CTₘₐₓ selected in the sub-step P22. If the whole of the corpus C has not yet been read completely in the sub-step P24, the module MDP repeats the sub-steps P21 to P23 for each graphic chain GCₖ that has been read, incrementing the pointer k.

On completion of reading the corpus, in the sub-step P25, the module MDP stores in the database BD the transition probability P(Tₙ) previously defined and estimates new transition probabilities as a function of the variables VT. Each new transition probability P(Tₙ) is estimated as equal to the ratio of the associated variable VTₙ to the sum of the variables VT of the transitions outgoing from the same transitions node. For example, for a state corresponding to a node having three outgoing transitions T₁, T₂ and T₃ of which the respective variables are VT₁, VT₂ and VT₃, the probability of the transition T₁ is VT₁/(VT₁+VT₂+VT₃).

The module MDP repeats the preceding sub-steps P21 to P26 as a function of the new transition probabilities until a significant convergence of the transition probabilities P(Tₙ) is obtained. Thus, the phoneticizer consists of the automaton combined in the above manner with the transition probabilities of the mesh of the automaton.

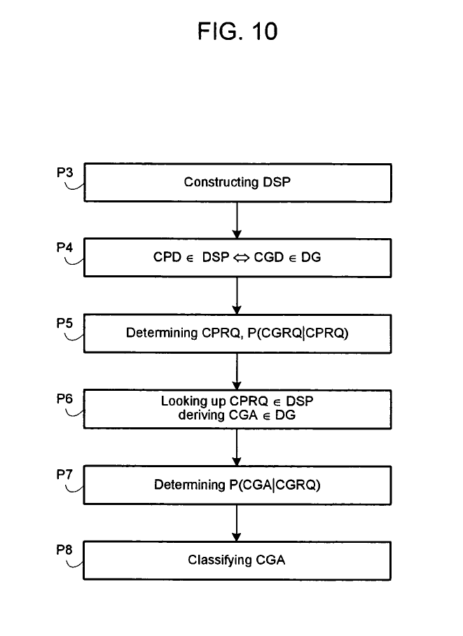

Referring now to FIG. 10, the usage error checking method implemented in the checking system SV includes main steps P3 to P8.

Referring to FIG. 1, the checking system incorporates the constructed stochastic phoneticizer P and the database BD that initially includes the graphic chains computer dictionary DG. The graphic chains stored in the dictionary DG are known as written forms and consist of patronymics, for example, which may include the name looked for by a user of the checking system. The following is an example of an extract from the graphic chains dictionary: jean, gean, genn. The checking system checks the accuracy of a required graphic chain CGRQ in a request by using the phoneticizer P to pair the chain CGRQ to one or more attested graphic chains CGA from the graphic chains dictionary. For this pairing, the phoneticizer groups two graphic chains by identifying their associated phonetic chains, called as phonetic signatures.

To be able to function, the checking system must have a computer dictionary DSP of phonetic signatures including phonetic chains CPD associated with the graphic chains CGD of the graphic chains dictionary DG. To this end, in the step P3, the construction module MCD in the phoneticizer constructs and progressively stores the dictionary DSP with the resulting phonetic signatures, in the phoneticizer P, respectively from transcriptions of graphic chains CGD read in the graphic chains dictionary DG. Referring to the above example relating to the graphic chains dictionary:

the transcription of “jean” gives the phonetic signatures “Z˜a” and “Zin”;

the transcription of “gean” gives the phonetic signatures “Z˜a” and “Zin”; and

the transcription of “genn” gives the phonetic signature “Zen”.

On each transcription of a graphic chain CGD into a phonetic signature CPD, the module MCD determines the transcription probability P(CGD|CPD) by means of the phoneticizer. Referring to the above example, there are obtained:

P(jean|Z˜a)=0.1;

P(jean|Zin)=0.9;

P(gean|Z˜a)=0.5;

P(gean|Zin)=0.5; and

P(genn|Zen)=0.6.

In the step P4, the module MEL establishes a computer link between each phonetic signature CPD from the phonetic signatures dictionary DSP and a corresponding graphic chain CGD from the graphic chains dictionary DG. A phonetic signature CPD includes as many links as there are graphic chains corresponding to the phonetic signature. The module MEL stores for each link the transcription probability P(CGD|CPD) of the phonetic signature CPD and the associated graphic chain CGD. For example, the phonetic signature |Z˜a” from the phonetic signatures dictionary is linked to the graphic chains “jean”]and “gean” stored in the graphic chains dictionary.

After the step P4, the usage error checking system is ready to function to check the accuracy of a required graphic chain CGRQ in a request and applied to the checking system SV.

The steps P5 to P8 concern the checking proper of a required graphic chain CGRQ in the checking system.

In the step P5, the module MTCRQ in the phoneticizer transcribes the required graphic chain CGRQ into at least one phonetic signature, i.e. one or several corresponding phonetic signatures CPRQ. For example, the required graphic chain CGRQ “jen” is transcribed via the phoneticizer into required phonetic signatures “Z˜a” and “Zen”. During the transcription of the required graphic chain CGRQ, probabilities P(CGRQ|CPRQ) of the transcription of said graphic chain into the phonetic signature or signatures are also determined, for example P(jen|Z˜a)=0.1 and P(jen|Zen)=0.9.

In the step P6, the module MRCD looks up in the phonetic signatures dictionary DSP phonetic signatures CPD that are either identical to the required phonetic signatures CPRQ or similar to them, depending on a similarity threshold. The module MRCD then derives from the phonetic signature CPD found in the dictionary DSP attested graphic chains CGA contained in the graphic chains dictionary DG. For example, for the required graphic chain “jen” associated with the phonetic signature “Z˜a”, the module MRCD produces the attested graphic chains “jean” and “gean” stored in the graphic chains dictionary DG. For the same required graphic chain “jen” associated with the phonetic signature “zen”, the module MRCD produces the attested graphic chain “genn”. These attested graphic chains are all linked to the same phonetic signature CPD “Z˜a” or “zen” stored in the phonetic signatures dictionary DSP. Each link linking an attested graphic chain CGA to a phonetic signature CPD is defined with a probability P(CGA˜CPD), for example P(jean|Z˜a)=0.1, P(gean|Z˜a)=0.5 and P(genn|Zen)=0.6.

In the step P7, the module MDPU determines probabilities of usage of the graphic chains CGA previously attested as a function of the required graphic chain. A usage probability is equal to the product of the probability P(CGA|CPD) of the transcription of an attested graphic chain CGA from the graphic chains dictionary DG into a phonetic signature CPD and the probability P(CGRQ|CPD) of the transcription of the required graphic chain CGRQ into said phonetic signature CPD (=CPRQ). Referring to the above example:

P(jean|jen)=P(jean|Z˜a)×P(jen|Z˜a)=0.01;

P(gean|jen)=P(gean|Z˜a)×P(jen|Z˜a)=0.05; and

P(genn|jen)=P(genn|Zen)×P(jen|Zen)=0.54.

In the step P8 the module MCL then classifies the attested graphic chains CGA for the request as a function of the usage probabilities previously determined, preferably in decreasing order of usage probability. Using the above example again, the classification of the solution graphic chains is: genn, gean and jean.

In a preferred embodiment, the steps AU1 and P2 of the automaton and phoneticizer construction methods are determined by the instructions of first and second programs incorporated in an electronic data processing system such as a server or a computer. The first program includes program instructions which, when said program is loaded into and executed in the electronic data processing system, whose operation is then controlled by the execution of the program, execute the steps of the automaton construction method of the invention. The second program includes program instructions which, when said program is loaded into and executed in the electronic data processing system, whose operation is then controlled by the execution of the program, execute the steps of the phoneticizer construction method of the invention.

Likewise the steps of the method for checking the accuracy of a required graphic chain by the usage error checking system SV including said phoneticizer are determined by the instructions of a third program incorporated in the electronic data processing system. The third program includes program instructions which, when said third program is loaded into and executed in the electronic data processing system, whose operation is then controlled by the execution of the program, execute the steps of the method of the invention for checking the accuracy of a graphic chain.

As a consequence, the invention applies also to computer programs, in particular computer programs on or in an information medium, adapted to implement the invention. These programs may use any programming language and be in the form of source code, object code or intermediate code between source code and object code, for example in a partially compiled form, or in any other form suitable for implementing the method of the invention.

The information medium may be any entity or device capable of storing programs. For example, the medium may include storage means, such as a ROM, for example a CD-ROM or a microelectronic circuit ROM, or magnetic storage means, for example a floppy disk or a hard disc.

Moreover, the information medium may be a transmissible medium such as an electrical or optical signal, which may be routed via an electrical or optical cable, by radio or by other means. The programs of the invention may in particular be downloaded over an Internet type network.

Alternatively, the information medium may be an integrated circuit in which the programs are incorporated the circuit being adapted to execute or to be used in the execution of the methods of the invention.

What I claim is:

1. A method of causing a computer to construct an automaton for compiling grapheme/phoneme transcription rules from an initial transcription corpus including pairs of chains, each pair having a graphic chain including graphic elements and a phonetic chain including phonetic elements, said method including the following steps that are performed after grapheme/phoneme correspondences have been registered in a database by aligning said graphic elements of the graphic chains with said phonetic elements of the phonetic chains associated with said graphic chains:
the method including the steps of:
deriving and storing transcription rules in said database on the basis of an analysis of left-hand and right-hand correspondences of each grapheme/phoneme correspondence in each pair of associated graphic and phonetic chains, and
causing said automaton to include states and state transitions derived from the registered transcription rules, each state being a link between two consecutive grapheme/phoneme correspondences in a pair of graphic and phonetic chains and each transition chaining two states having a correspondence in common.

2. The method of claim 1, including creating and numbering states as a function of said stored transcription rules and chaining said erected and numbered states by transitions depending on correspondences common to said states.

3. The method of claim 1, including creating initial end states of said automaton.

4. The method of claim 1, wherein said aligning includes inserting terminal grapheme/phoneme correspondences respectively at the start and the end of each pair of graphic and phonetic chains.

5. An automaton construction computer system for constructing an automaton for compiling grapheme/phoneme transcription rules, said system including:
a database in which is stored an initial transcription corpus comprising pairs of chains, each of the pairs having a graphic chain including graphic elements and a phonetic chain including phonetic elements,
a module for deriving and storing transcription rules in said database on the basis of an analysis of left-hand and right-hand correspondences of each grapheme/phoneme correspondence in each pair of graphic and phonetic chains, all the correspondences being determined by an alignment module for aligning graphic elements of said graphic chains with phonetic elements of said phonetic chains in grapheme/phoneme correspondences stored in said database, and
a module for constructing said automaton and storing it in the form of a file in said database, said automaton including states and state transitions derived from the registered transcription rules, each state being a link between two consecutive grapheme/phoneme correspondences in a pair of graphic and phonetic chains, and each transition chaining two states having a correspondence in common.

6. A memory storing a computer program adapted to be executed on an automaton construction computer system for constructing an automaton for compiling grapheme/phoneme transcription rules from an initial transcription corpus having pairs each including a graphic chain including graphic elements and a phonetic chain including phonetic elements,
said program including program instructions which, when said program is loaded into and executed in said automaton construction computer system causes the automation construction computer system to execute the steps of claim 1 that are performed after grapheme/phoneme correspondences have been registered in a database by alignment of said graphic elements of the graphic chains with said phonetic elements of the phonetic chains associated with said graphic chains.

7. A method of causing a computer to construct a phoneticizer from a corpus stored in a database and including pairs of chains, each pair having a graphic chain including graphic elements and a phonetic chain including phonetic elements, said method including the steps of:
constructing and storing in said database an automaton for compiling transcription rules resulting from an analysis of grapheme/phoneme correspondences in pairs of chains read in said corpus, said automaton including states and state transitions derived from transcription rules, each state being a link between two consecutive grapheme/phoneme correspondences in a pair of graphic and phonetic chains, and each transition chaining two states having a grapheme/phoneme correspondence in common, said transitions relating to the transcription of a graphic chain into a phonetic chain forming a path of transitions in said automaton, and
determining and storing in said database probabilities of the transitions at the output of nodes of the automaton situating the grapheme/phoneme correspondences common to said transitions, in order to construct said phoneticizer by combining said automaton and the determined transition probabilities.

8. The method of claim 7, wherein construction of the automaton includes:
aligning said graphic elements of said graphic chains with said phonetic elements of said phonetic chains associated with said graphic chains into grapheme/phoneme correspondences,
registering transcription rules on the basis of an analysis of left-hand and right-hand correspondences of each grapheme/phoneme correspondence in each pair of associated graphic and phonetic chains,
constructing said automaton so the automation includes states and state transitions derived from the registered transcription rules, and
storing said automaton in said database in the form of a file.

9. The method of claim 7, wherein said transition probability determining step includes:
weighting each transition of said automaton by an arbitrarily selected transition probability,
determining a probability of at least one path of transitions representative of the transcription of each graphic chain into at least one associated phonetic chain as a function of the probabilities of the transitions of the path,
selecting, for each graphic chain of said path, transitions having the highest probability,
incrementing variables respectively associated with said transitions and representative of numbers of crossings of said transitions by said selected transition paths, and
estimating new transition probabilities as a function of the previously determined transition variables.

10. The method of claim 9, wherein said transition probability determining step further includes reiterating the selecting, incrementing and estimating steps used to determine path probability as a function of new transition probabilities until significant convergence of said transition probabilities is obtained, in order to combine said automaton and said transition probabilities in said phoneticizer.

11. A computer system for constructing a phoneticizer from a corpus stored in a database and pairs of chains, each pair including a graphic chain including graphic elements and a phonetic chain including phonetic elements, said computer system including:
a module for constructing and storing in said database an automaton for compiling transcription rules resulting from an analysis of grapheme/phoneme correspondences in the pairs of chains read in said corpus, said automaton including states and state transitions derived from transcription rules, each state being a link between two consecutive grapheme/phoneme correspondences in a pair of graphic and phonetic chains, and each transition chaining two states having a grapheme/phoneme correspondence in common, the transitions relating to the transcription of a graphic chain into a phonetic chain forming a path of transitions in said automaton, and
a module for determining and storing in said database probabilities of the transitions at an output of nodes of said automaton situating the grapheme/phoneme correspondences common to said transitions, in order to construct said phoneticizer by combining said automaton and the determined transition probabilities.

12. A memory storing a computer program adapted to be executed on a phoneticizer construction computer system for constructing a phoneticizer from a corpus stored in a database and comprising pairs of chains, each of the chains including a graphic chain including graphic elements and a phonetic chain including phonetic elements,
said program including program instructions which, when said program is loaded into and executed in said phoneticizer construction computer system, causes the computer system to execute the steps of claim 7.

13. A computer method of checking the accuracy of a required graphic chain by using a phoneticizer and a computer dictionary of graphic chains, including the following steps:
constructing said phoneticizer by causing a computer arrangement to construct an automaton for compiling transcription rules resulting from an analysis of grapheme/phoneme correspondences in pairs of graphic chain and phonetic chain read in a corpus and determining probabilities of transitions between grapheme/phoneme correspondences,
using said phoneticizer to construct a dictionary of phonetic signatures by transcribing each of said graphic chains from said graphic chains dictionary into at least one phonetic signature, linking the phonetic signatures to said graphic chains, and determining probabilities of transcription of said graphic chains into said phonetic signatures,
using said phoneticizer to determine a transcription from said required graphic chain into at least one request phonetic signature and determining a probability of the preceding transcription, and
looking up phonetic signatures in a phonetic signatures dictionary, the phonetic signatures that are looked up being substantially identical to said at least one request phonetic signature, the looking up of phonetic signatures resulting in attested graphic chains being stored in said graphic chains dictionary and linked to said at least one phonetic signature.

14. The method of claim 13, further including determining probabilities of usage of said attested graphic chains as a function of the determined probability of the preceding transcription, and classifying said attested graphic chains as a function of the determined probabilities of usage.

15. A system for checking the accuracy of a required graphic chain, said system including:
a phoneticizer; and
a dictionary of graphic chains;
said system being arranged for performing the method of claim 13.

16. A memory storing a computer program adapted to be executed on a checking system for checking the accuracy of a required graphic chain, said checking system including a phoneticizer and a dictionary of graphic chains,
said program including program instructions, which, when said program is loaded into and executed in said checking system, causes the checking system to execute the steps of claim 13.

17. A method of transcribing a required graphic chain into a phonetic signature using a dictionary of graphic chains, said method comprising:
constructing a dictionary of phonetic signatures by transcribing each of said graphic chains from said graphic chains dictionary into at least one phonetic signature and linking the phonetic signatures to said graphic chains,
determining probabilities of transcriptions of said graphic chains into said phonetic signatures,
determining a transcription of said required graphic chain into at least one request phonetic signature, and
determining the probability of the preceding transcription.

18. A phoneticizer for performing the method of claim 17.

19. A memory storing computer program adapted to be performed on a computer arrangement that functions as a phoneticizer, the computer program stored by the memory causing the computer arrangement to perform the steps of claim 17.

20. The method of claim 1, further including storing said automation that includes the states and state transitions in said database in the form of a file.
